(19) United States
(12) Patent Application Publication
(10) Pub. No.: US 2018/0333937 A1
(43) Pub. Date: Nov. 22, 2018

(54) TRANSFER FILM, AND TRANSFER STICKER AND GLASS PRODUCT USING THE SAME

(71) Applicant: HON HAI PRECISION INDUSTRY CO., LTD., New Taipei (TW)

(72) Inventors: WEI-TING CHEN, New Taipei (TW); CHEN-CHU CHIANG, New Taipei (TW); HAN-LUNG LEE, New Taipei (TW); YI-ZHONG SHEU, New Taipei (TW); HUNG-CHUN MA, New Taipei (TW); YU-LIN LIAO, New Taipei (TW); CHIH-JUNG CHANG, New Taipei (TW); JIH-CHEN LIU, New Taipei (TW); FENG-YUEN DAI, New Taipei (TW)

(21) Appl. No.: 15/647,217

(22) Filed: Jul. 11, 2017

(30) Foreign Application Priority Data
May 18, 2017 (TW) 106116497

(51) Int. Cl. B32B 17/06; B32B 7/12; B32B 15/20

(52) U.S. Cl. CPC B32B 17/064; B32B 2307/75; B32B 15/20; B32B 7/12

(57) ABSTRACT

A transfer film providing a textured finish to the surface of a glass object comprises a color ink layer, a texture layer attached to a surface of the ink layer, a metal layer attached to a surface of the texture layer opposite from and contacting the ink layer, and an adhesive layer attached to a surface of the metal layer opposite from and contacting the texture layer. A transfer sticker and a glass product using the transfer film are also provided.

### FIELD

The disclosure generally relates to a transfer film, and a transfer sticker and a glass product using the transfer film.

### BACKGROUND

Glass products are widely used nowadays. A surface of the glass product is generally decorated to make the glass product look better. Transfer film is used to attach to the surface of the glass product to decorate the glass product. If the transfer film does not have texture layer, the glass product decorated by the transfer film cannot have a textured finish.

### BRIEF DESCRIPTION OF THE DRAWINGS

Implementations of the present technology will now be described, by way of example only, with reference to the attached figures.

FIG. 1 is a diagrammatic view of a transfer film according to an exemplary embodiment of the present application.

FIG. 2 is a diagrammatic view of a transfer sticker using the transfer film of FIG. 1.

FIG. 3 is a flowchart of a method for making a transfer sticker in accordance with an exemplary embodiment.

FIG. 4 is a diagrammatic view of a glass product using the transfer film of FIG. 1.

FIG. 5 is a flowchart of a method for making a glass product in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

Several definitions that apply throughout this disclosure will now be presented.

The term “comprising” when utilized, means “including, but not necessarily limited to”; it specifically indicates open-ended inclusion or membership in the so-described combination, group, series, and the like.

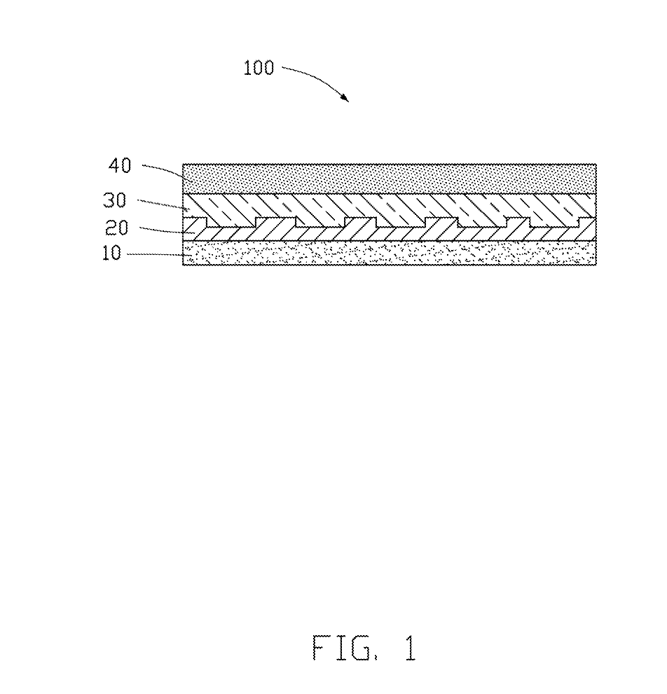

FIG. 1 illustrates an exemplary embodiment of a transfer film 100 including a color ink layer 10, a texture layer 20 attached to a surface of the ink layer 10, a metal layer 30 attached to a surface of the texture layer 20 opposite from and contacting (or attached to) the ink layer 10, and an adhesive layer 40 attached to a surface of the metal layer 30 opposite from and contacting (or attached to) the texture layer 20.

The ink layer 10 has color, thus the transfer film 100 has the color of the ink layer 10. The ink layer 10 may be formed by printing or spraying.

The texture layer 20 may be made of an ultraviolet curable resin. The ultraviolet curable resin may be acrylic copolymer. Acrylic copolymer cures fast in ultraviolet light. The texture layer 20 may be formed by embossing.

The metal layer 30 may be made of aluminum, copper, zinc, silver, platinum, titanium, or any combination thereof. The metal layer 30 is formed by non conductive plating method. The non conductive plating method may be evaporation or sputtering.

The adhesive layer 40 may be made of ethylene vinyl acetate copolymer, acrylic resin, monomethyl ether propylene glycol acetate, or any combination thereof. In at least one exemplary embodiment, the adhesive layer 40 comprises a combination of ethylene vinyl acetate copolymer and acrylic resin.

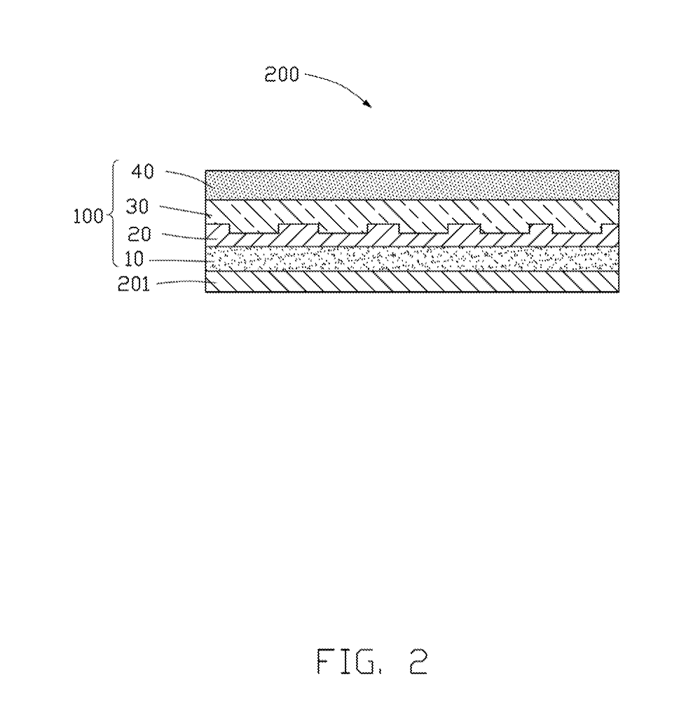

FIG. 2 illustrates a transfer sticker 200 including a releasing film 201 and a transfer film 100 attached to at least one surface of the releasing film 201. The transfer film 100 includes an ink layer 10 attached to a surface of the releasing film 201, a texture layer 20 attached to a surface of the ink layer 10 opposite from and contacting (or attached to) the releasing film 201, a metal layer 30 attached to a surface of the texture layer 20 opposite from and contacting (or attached to) the ink layer 10, and an adhesive layer 40 attached to a surface of the metal layer 30 opposite from and contacting (or attached to) the texture layer 20.

The releasing film 201 may be made of polyolefine (PO), polyester (PET), or any combination thereof.

In at least one exemplary embodiment, the transfer sticker 200 further includes a protecting film (not shown) attached to a surface of the adhesive layer 40 opposite from and contacting (or attached to) the metal layer. The protecting film can prevent the adhesive layer 40 from contamination.

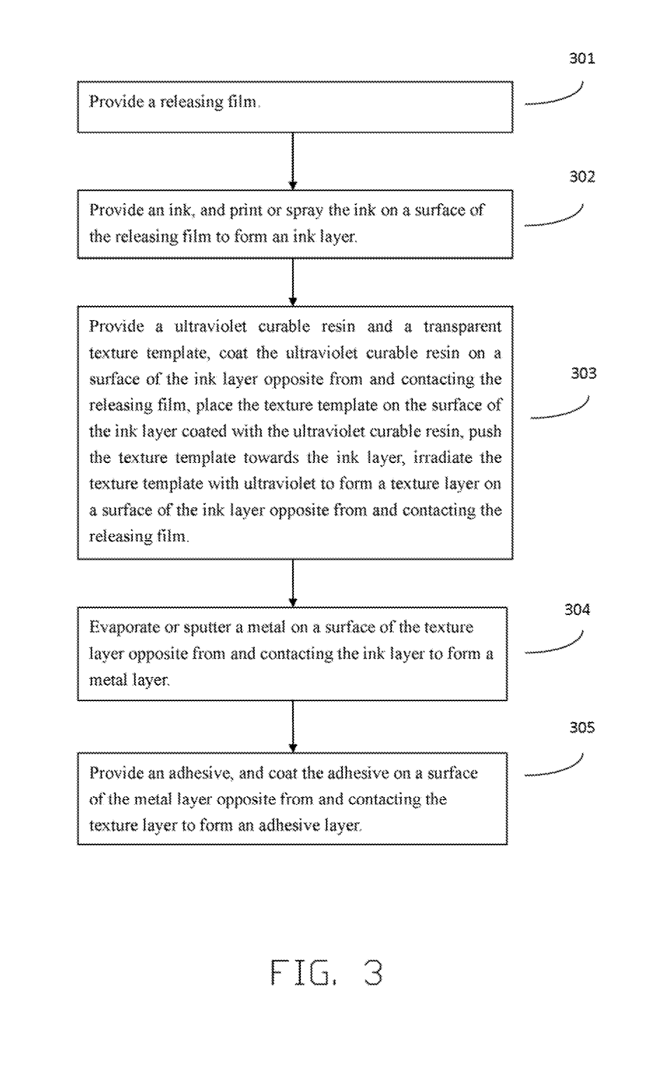

FIG. 3 illustrates a flowchart of an exemplary method for making the transfer sticker 200 in accordance with an exemplary embodiment. The exemplary method is provided by way of example, as there are a variety of ways to carry out the method. Each block shown in the figure represents one or more processes, methods or subroutines, carried out in the exemplary method. Furthermore, the illustrated order of blocks is by example only, and the order of the blocks can change. Additional blocks may be added, or fewer blocks may be utilized, without departing from this disclosure. The exemplary method may begin at block 301.

At block 301, a releasing film 201 is provided. The releasing film 201 may be made of polyolefine, polyester, or any combination thereof.

At block 302, an ink is provided, the ink being printed or sprayed on a surface of the releasing film 201 to form an ink layer 10.

At block 303, an ultraviolet curable resin and a transparent texture template (not shown) are provided. The texture template includes a surface defining a plurality of textures. The ultraviolet curable resin is coated on a surface of the ink layer 10 opposite from and contacting (or attached to) the releasing film 201, and the texture template is placed on the surface of the ink layer 10 coated with the ultraviolet curable resin. The texture template is pushed towards the ink layer 10, the texture template is irradiated with ultraviolet light, causing the ultraviolet curable resin to undergo an ultraviolet solidifying reaction, forming a texture layer 20 on a surface of the ink layer 10 opposite from and contacting (or attached to) the releasing film 201. The template is then removed.

In at least one exemplary embodiment, the ultraviolet curable resin may be, but is not limited to, acrylic copolymer.

At block 304, a metal is evaporated or sputtered on a surface of the texture layer 20 opposite from and contacting (or attached to) the ink layer 10 to form a metal layer 30 on the surface of the texture layer 20 opposite from and contacting (or attached to) the ink layer 10.

In at least one exemplary embodiment, the metal may be, but is not limited to, aluminum, copper, zinc, silver, platinum, titanium, or any combination thereof.

At block 305, an adhesive is provided and coated on a surface of the metal layer 30 opposite from and contacting (or attached to) the texture layer 20 to form an adhesive layer 40 on the surface of the metal layer 30 opposite from and contacting (or attached to) the texture layer 20.

In at least one exemplary embodiment, the adhesive may be, but is not limited to, ethylene vinyl acetate copolymer, acrylic resin, monomethyl ether propylene glycol acetate, or any combination thereof. In at least one exemplary embodiment, the adhesive is a combination of ethylene vinyl acetate copolymer and acrylic resin.

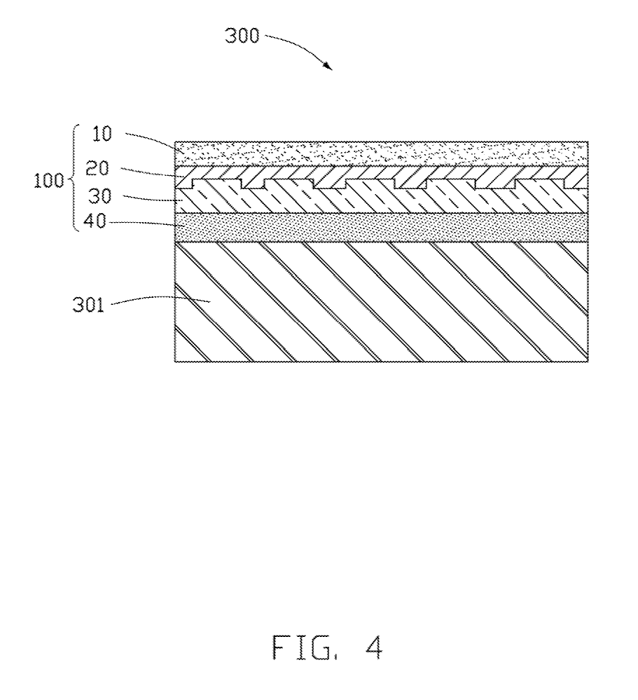

FIG. 4 illustrates a glass product 300 including a glass substrate 301 and a transfer film 100 attached to at least one surface of the glass substrate 301. The transfer film 100 includes an adhesive layer 40 attached to a surface of the glass substrate 301, a metal layer 30 attached to a surface of the adhesive layer 40 opposite from and contacting (or attached to) the glass substrate 301, a texture layer 20 attached to a surface of the metal layer 30 opposite from and contacting (or attached to) the adhesive layer 40, and an ink layer 10 attached to a surface of the texture layer 20 opposite from and contacting (or attached to) the metal layer 30.

The glass substrate 301 may be a flat glass or a curved glass.

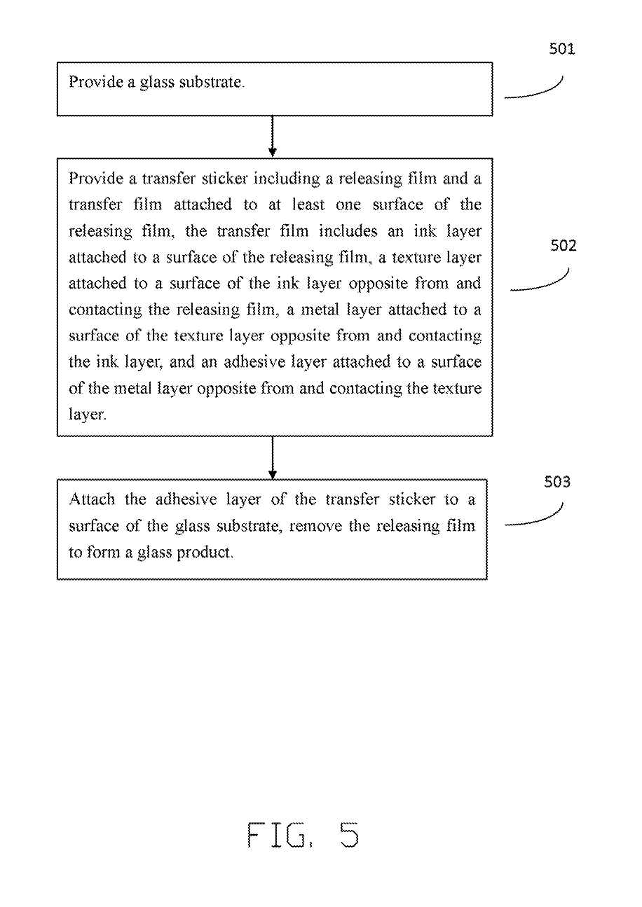

FIG. 5 illustrates a flowchart of a method for making a decorated and finished glass product 300 in accordance with an exemplary embodiment. The exemplary method is provided by way of example, as there are a variety of ways to carry out the method. Each block shown in the figure represents one or more processes, methods or subroutines, carried out in the exemplary method. Furthermore, the illustrated order of blocks is by example only, and the order of the blocks can change. Additional blocks may be added, or fewer blocks may be utilized, without departing from this disclosure. The exemplary method may begin at block 501.

At block 501, a glass substrate 301 is provided. The glass substrate 301 may be a flat glass or a curved glass.

At block 502, a transfer sticker 200 is provided. The transfer sticker 200 includes a releasing film 201 and a transfer film 100 attached to at least one surface of the releasing film 201. The transfer film 100 includes an ink layer 10 attached to a surface of the releasing film 201, a texture layer 20 attached to a surface of the ink layer 10 opposite from and contacting (or attached to) the releasing film 201, a metal layer 30 attached to a surface of the texture layer 20 opposite from and contacting (or attached to) the ink layer 10, and an adhesive layer 40 attached to a surface of the metal layer 30 opposite from and contacting (or attached to) the texture layer 20. The releasing film 201 may be made of polyolefine (PO), or polyester (PET).

At block 503, the adhesive layer 40 of the transfer sticker 200 is attached to a surface of the glass substrate 301, the releasing film 201 can finally be removed to form a glass product 300.

The glass product 300 undergoes an adhesion strength test under ASTM standard, a surface hardness test, an abrasion resistance test, an ultraviolet resistance test, a solvent resistance test, thermal shock and high temperature and humidity resistance (Miniloop) tests, and a chemical resistance test.

The adhesion strength test shows that an adhesion strength of the transfer film 100 with the glass substrate 301 is 5 B.

The surface hardness test is carried out by pencil hardness test method, and the surface hardness test shows that a surface hardness of the transfer film 100 is H.

The abrasion resistance test is carried out by RCA abrasion resistance test. Test conditions of the RCA abrasion resistance test are a weight-bearing of 175 gf, and a rotational speed of about 16 rpm to about 17 rpm. The abrasion resistance test shows that the glass substrate 301 is not exposed by these tests.

The ultraviolet resistance test is carried out by putting the glass product 300 under ultraviolet light for 4 hours, then exposing the glass product 300 to a constant temperature and humidity environment for 4 hours, repeating the uv exposure, constant temperature, and humidity environment testing 12 cycles. A wavelength of the ultraviolet is 340 nm, an irradiance is 0.63 W/m², the constant temperature is 50 degrees Celsius, and the humidity is 95% R·T. The ultraviolet resistance test result is that the transfer film 100 does not change or suffer damage.

The solvent resistance test is carried out by wiping the transfer film 100 by isopropyl alcohol, petroleum ether, or artificial sweat 200 times in 2 minutes. The solvent resistance test shows that the transfer film 100 does not change or suffer damage.

The Miniloop test is carried out by providing a temperature shock box including a cold box and a hot box, a temperature of the cold box is 40 degrees Celsius below zero, a temperature of the hot box is 70 degrees Celsius; putting the glass product 300 in the cold box for 2 hours, and then putting the glass product 300 in the hot box, repeating 5 times. The Miniloop test result is that the transfer film 100 does not change or suffer damage.

The chemical resistance test is carried out by coating a hand cream, a sunscreen cream, a lipstick, a foundation cream, a black whirlwind pesticide, or an arowana cooking oil on the surface of the transfer film 100, then letting the coated transfer film sit for 24 hours. The chemical resistance test result shows that the transfer film 100 does not change or suffer damage.

The test results above show that the transfer film 100 has improved adhesion strength, surface hardness, abrasion resistance, ultraviolet resistance, solvent resistance, thermal shock and high temperature and humidity resistance, and chemical resistance.

The embodiments shown and described above are only examples. Even though numerous characteristics and advantages of the present technology have been set forth in the foregoing description, together with details of the structures and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. A transfer film comprising:
an ink layer;
a texture layer attached to a surface of the ink layer;
a metal layer attached to a surface of the texture layer opposite from and contacting the ink layer; and
an adhesive layer attached to a surface of the metal layer opposite from and contacting the texture layer.

2. The transfer film of claim 1, wherein the texture layer comprises an ultraviolet curable resin.

3. The transfer film of claim 2, wherein the ultraviolet curable resin comprises acrylic copolymer.

4. The transfer film of claim 1, wherein the metal layer comprises aluminum, copper, zinc, silver, platinum, titanium, and any combination thereof.

5. The transfer film of claim 1, wherein the adhesive layer comprises ethylene vinyl acetate copolymer, acrylic resin, monomethyl ether propylene glycol acetate, and any combination thereof.

6. A transfer sticker comprising:
a releasing film; and
a transfer film attached to at least one surface of the releasing film, the transfer film comprising:
an ink layer;
a texture layer attached to a surface of the ink layer;
a metal layer attached to a surface of the texture layer opposite from and contacting the ink layer; and
an adhesive layer attached to a surface of the metal layer opposite from and contacting the texture layer.

7. The transfer sticker of claim 6, wherein the texture layer comprises an ultraviolet curable resin.

8. The transfer sticker of claim 7, wherein the ultraviolet curable resin comprises acrylic copolymer.

9. The transfer sticker of claim 6, wherein the metal layer comprises aluminum, copper, zinc, silver, platinum, titanium, and any combination thereof.

10. The transfer sticker of claim 6, wherein the adhesive layer comprises ethylene vinyl acetate copolymer, acrylic resin, monomethyl ether propylene glycol acetate, and any combination thereof.

11. A glass product comprising:
a glass substrate; and
a transfer film attached to at least one surface of the glass substrate, the transfer film comprising:
an adhesive layer attached to a surface of the glass substrate;
a metal layer attached to a surface of the adhesive layer opposite from and contacting the glass substrate;
a texture layer attached to a surface of the metal layer opposite from and contacting the adhesive layer; and
an ink layer attached to a surface of the texture layer opposite from and contacting the metal layer.

12. The glass product of claim 11, wherein the texture layer comprises an ultraviolet curable resin.

13. The glass product of claim 12, wherein the ultraviolet curable resin comprises acrylic copolymer.

14. The glass product of claim 11, wherein the metal layer comprises aluminum, copper, zinc, silver, platinum, titanium, and any combination thereof.

15. The glass product of claim 11, wherein the adhesive layer comprises ethylene vinyl acetate copolymer, acrylic resin, monomethyl ether propylene glycol acetate, and any combination thereof.
